(19) United States
(12) Patent Application Publication
(10) Pub. No.: US 2011/0115245 A1
(43) Pub. Date: May 19, 2011

(54) Ambulette Insert

(75) Inventors: Roy Frank Engelbrecht, Charlotte, MI (US); Russell Floyd Rugg, Bellevue, MI (US); Terry Kyle Olson, Greenfield, WI (US); Michael Allen Campeau, Lansing, MI (US)

(73) Assignee: SPARTAN MOTORS, INC., Charlotte, MI (US)

(21) Appl. No.: 12/948,912

(22) Filed: Nov. 18, 2010

Related U.S. Application Data
(60) Provisional application No. 61/262,358, filed on Nov. 18, 2009.

(51) Int. Cl. A61G 3/00

(52) U.S. Cl. 296/19; 296/24.38

(57) ABSTRACT

An ambulette insert is provided. The ambulette insert includes a floor plate adapted to mount to the existing mounting holes of the floor of a vehicle. The floor plate includes a gurney latching system for locking a gurney carried by the vehicle to the floor plate. An equipment console extends between the interior sidewalls of the vehicle and includes a plurality of medical equipment and storage. The ambulette insert also includes a light unit extending away from the equipment console that is designed to provide variable intensity lighting. The light unit is supported by a support conduit that has a hollow core for the routing of various electrical cables and hoses to the equipment console and light unit. The ambulette insert is designed to mount with the existing mounting features of the vehicle so that no additional machining of the vehicle is required.

### CROSS-REFERENCE TO RELATED PATENT APPLICATIONS

This patent application claims the benefit of U.S. Provisional Patent Application No. 61/262,358, filed Nov. 18, 2009, the entire teachings and disclosure of which are incorporated herein by reference thereto.

### FIELD OF THE INVENTION

This invention generally relates to non-emergency medical purpose vehicles and more particularly to modular inserts for converting a general purpose vehicle into a non-emergency medical purpose vehicle.

### BACKGROUND OF THE INVENTION

Contemporary ambulances are configured to provide moderate to advanced immediate medical care in emergency situations. To provide such care, ambulances typically require an array of advanced technical equipment, and a multi-person crew to operate the same. As a result, ambulances are costly to manufacture and operate. Therefore, hospitals and other medical organizations are typically under budget constraints with regard to how many ambulances they can utilize in their business.

Unfortunately, there is a growing use of ambulance transportation for non-emergency medical situations, e.g. for transportation to the hospital for a routine appointment. Typically, a person will call a hospital and report emergency type symptoms to obtain a ride to the hospital via an ambulance. Once at the hospital, the person will attend to non-emergency affairs such as routine appointments, and seeing that their prescriptions get refilled. This type of use results in the inefficient employment of an ambulance.

Given that hospitals typically have a limited number of ambulances at their disposal, the use of an ambulance for a ride to the hospital when no immediate medical care is needed can potentially prevent someone with a serious medical emergency of utilizing the same ambulance to get to the hospital immediately. Furthermore, the growing inefficient use of ambulances can increase the overall cost of healthcare because medical facilities must add additional ambulances to their fleet to ensure they can meet the medical needs of their area of responsibility.

In response to the growing use of ambulances for non-emergency situations, many hospitals and other entities are incorporating “ambulettes” into their existing fleet to serve as an alternative to ambulances. An ambulette is designed to provide short or long distance transportation in a non-emergency situation. Ambulettes typically incorporate a variety of common medical equipment ideal for use during non-emergency transportation.

Due in part to their non-emergency application, ambulettes are not required to meet the more stringent regulatory standards of ambulances. Additionally, ambulettes typically have the body styling of a van or similar utility type vehicle, both of which are considerably smaller in size and less in cost than an ambulance. As a result, the use of ambulettes is increasing in frequency as a cost effective measure to reduce the use of ambulances in non-emergency situations.

Currently, ambulettes are typically a custom made vehicle designed from the “ground up.” As a result, it can be costly for a hospital or other medical organization to add ambulettes to their fleet given that they must purchase an entirely new, custom made, vehicle. Therefore, it is desirable to have a modular insert that can quickly adapt an existing stock vehicle such that the vehicle thereafter functions as an ambulette. It is further desirable that such an insert use the existing mounting holes and support structure of a given vehicle to avoid excessive machining during installation by the end user.

The invention provides such a modular insert. These and other advantages of the invention, as well as additional inventive features, will be apparent from the description of the invention provided herein.

### BRIEF SUMMARY OF THE INVENTION

In one embodiment, the invention provides a modular ambulette insert that facilitates the rapid, low cost reconfiguration of a stock vehicle into an ambulette. The modular ambulette insert according to this embodiment includes a floor plate configured to mount to a floor of the vehicle. A support conduit extends generally upward and away from the floor plate. A medical console is supported by the support conduit and disposed above the floor plate.

In a further embodiment, the medical console includes an equipment console and a light unit. In another embodiment, the light unit extends transversely away from the equipment console. In another embodiment, the light unit has an internal cavity adapted to route mechanical and electrical leads from the equipment console and the light unit to the support conduit.

In another embodiment, the floor plate includes a plurality of mounting holes. The plurality of mounting holes are adapted to align with pre-existing mounting locations of a vehicle. In a further embodiment, the floor plate includes a gurney latching system mounted thereto. In yet a further embodiment, the floor plate includes an attendant seat mounted thereto.

In another embodiment, the ambulette insert further comprises a suction system including mechanical leads that extend from a base unit to the equipment console. The mechanical leads extend through a cavity of the light unit. In another embodiment, the ambulette insert includes an oxygen system. The oxygen system includes mechanical leads that extend from a tank thereof to the equipment console, the mechanical leads extending through the cavity of the light unit.

In another embodiment, a method for configuring a light commercial vehicle to operate as an ambulette is provided. A method according to this embodiment includes the steps of installing a modular ambulette insert in an interior of the vehicle. The method further includes mounting the modular insert to the existing mounting locations of the vehicle.

In another embodiment, the method includes mounting a support conduit to a floor plate of the modular insert and mounting a medical console to the support conduit prior to the step of installing the modular ambulette insert in the interior of the vehicle.

In another embodiment, the method further includes mounting an attendant seat to the floor plate prior to the step of installing the modular ambulette insert into the interior of the vehicle.

In yet another embodiment, the step of mounting the modular insert includes mechanically affixing a floor plate of the modular ambulette insert to a floor of the vehicle. In another embodiment, the step of mechanically affixing includes mechanically affixing the floor plate to the floor of the vehicle using tension indicating bolts.

In another embodiment, the method includes affixing sidewall coverings to interior walls of the vehicle.

In another embodiment, the step of installing the modular insert includes affixing a support conduit to the floor plate after mechanically affixing the floor plate to the floor of the vehicle. In another embodiment, the method further includes the step of affixing a medical console to the interior of the vehicle and to the support conduit after affixing the support conduit to the floor plate. In another embodiment, the method includes the step of affixing an attendant seat to the floor plate after mechanically affixing the floor plate to the floor of the vehicle.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an ambulette insert partially installed in a vehicle;

FIG. 2 is a partially exposed side view of the ambulette insert of FIG. 1 fully installed in the vehicle of FIG. 1;

FIG. 3 is an exploded view of a floor plate and attendant seat of the ambulette insert of FIG. 1;

FIG. 4 is an exploded view of the ambulette insert of FIG. 1 and equipment associated therewith;

FIG. 5 is a perspective view of an equipment console of the ambulette insert of FIG. 1;

FIG. 6 is a front view of a light unit of the ambulette insert of FIG. 1; and

FIG. 7 is a perspective view of a support conduit of the ambulette insert of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

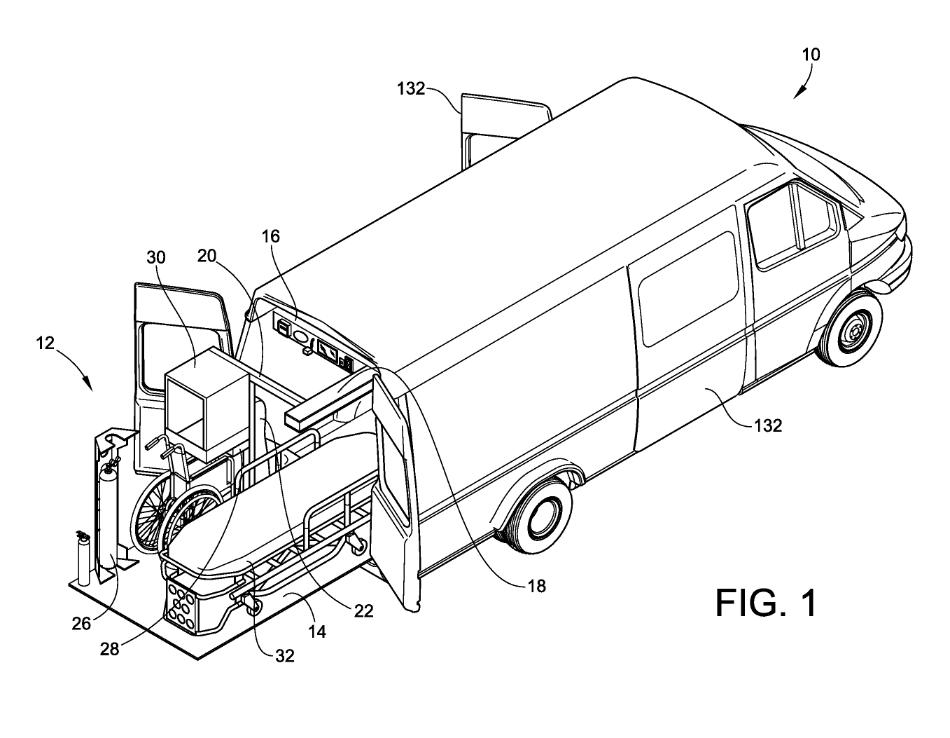

Turning now to the drawings, an ambulette insert 12 partially installed in a vehicle 10 is illustrated in FIG. 1. The ambulette insert 12 is designed to rapidly adapt an existing vehicle 10 to function as an ambulette type vehicle that is configured to provide short and long distance transportation in non-emergency situations. As will be discussed in greater detail below, the ambulette insert 12 accomplishes this functionality by a modular approach incorporating a relatively few number of components and using the existing mounting holes of vehicle such that no additional machining to the vehicle 10 is required to mount the ambulette insert 12 therein.

The ambulette insert 12 can be supplied as a stand alone modular unit such that it can be installed into a vehicle in a single step, or several steps alternatively. The ambulette insert 12 is designed to mate with the existing mounting locations of a light commercial vehicle. It will be understood that utility type light commercial vehicles typically include generally standardized mounting locations, and reference will be made thereto in the following. Although the following will describe the ambulette insert 12 in the context of a light commercial vehicle 10 such as a van or other utility vehicle, it will be recognized that the ambulette insert can be scaled up or down to accommodate various sizes of vehicles. As such, the following usage of a light commercial vehicle 10 should be taken by way of example, and not as a limitation.

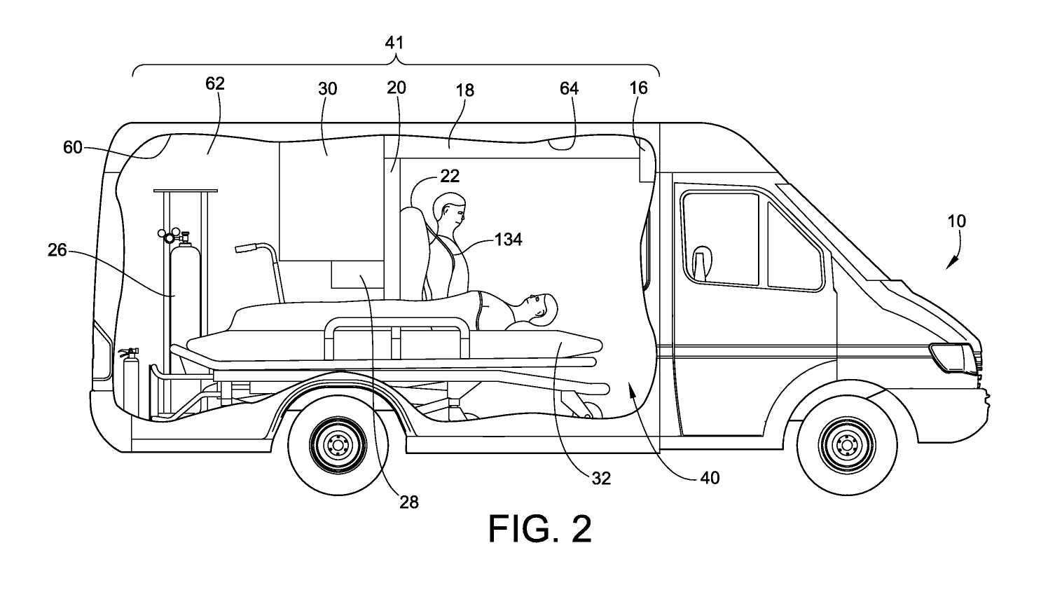

The ambulette insert 12 includes a floor plate 14 that covers a substantial portion of an interior floor of the vehicle 10. The ambulette insert also includes a medical console that includes an equipment console 16 and a light unit 18. The equipment console 16 extends between interior sidewalls 62, 64 (see FIG. 2) of the vehicle 10. The light unit 18 extends away from the equipment console 16 and is supported by a support conduit 20. An attendant seat 22 is fixedly mounted to the floor plate 14 such that an attendant is seated directly behind the driver of the vehicle 10. An attendant seated in the attendant seat 22 can access various pieces of medical equipment mounted within the medical console. Also, as will be discussed in greater detail below, a patient can be loaded onto a gurney that in turn can be locked to the floor plate 14 for safe transport of the patient. The attendant can remain seated in the attendant seat 22 and provide medical attention to the patient during transport.

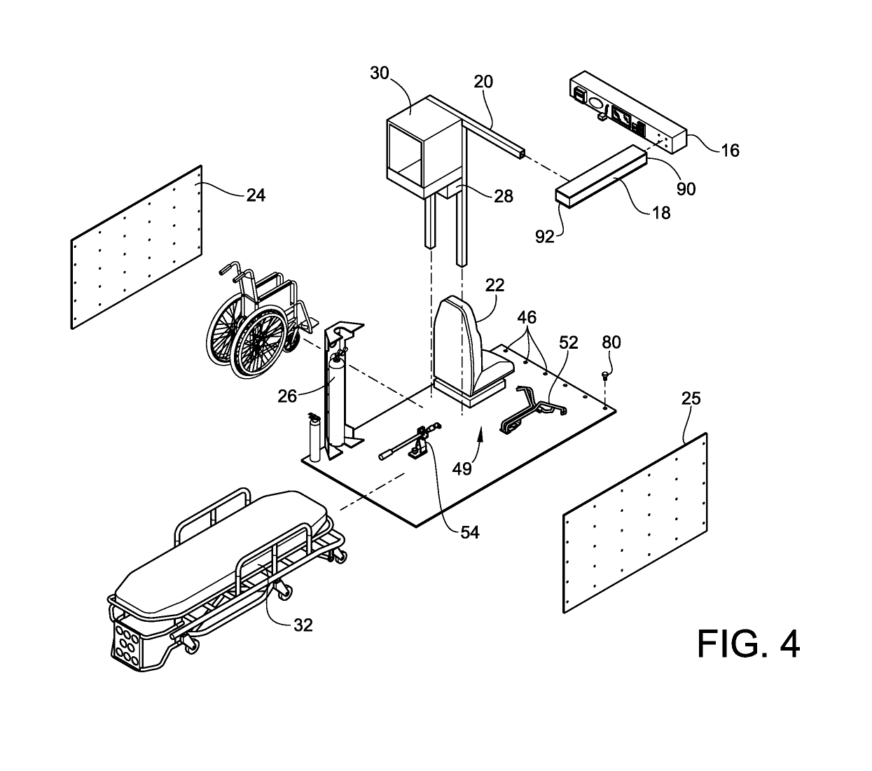

With momentary reference to FIG. 4, the ambulette insert 12 also includes sidewall coverings 24, 25. The sidewall coverings 24, 25 cover the interior sidewalls 62, 64 (see FIG. 2) of the vehicle 10 and provide both sound and thermal installation. The sidewall coverings 24, 25 are designed to mount to the existing mounting holes of the vehicle so that no additional machining of the vehicle 10 (see FIG. 1) is required. The sidewall covering 24, 25 may be installed before or after the installation of the floor plate 14.

Turning back to FIG. 1, the ambulette insert 12 can be supplied with, or later retrofitted to include, an oxygen system 26 and a suction system 28. The oxygen tank for the oxygen system 26 is contained by the ambulette insert 12 proximate to the rear of the vehicle 10. The suction system 28 has a base unit contained by the ambulette insert 12 also proximate the rear of the vehicle 10. As will be discussed in greater detail below, the support conduit 20 enables routing of the tubing of the oxygen system 26 and the suction system 28 from the rear of the vehicle 10 up to various ports located in the light unit 18 and the equipment console 16.

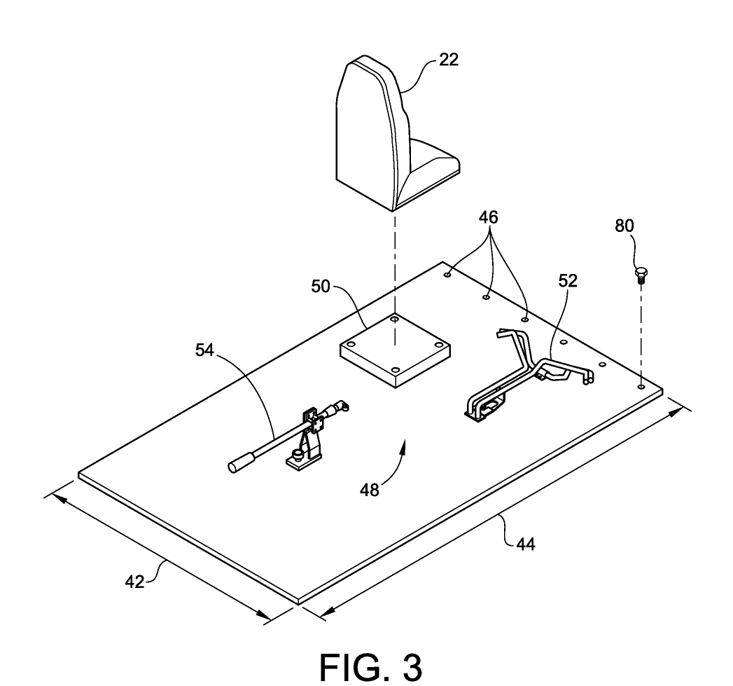

With reference now to FIG. 3, the floor plate 14 is illustrated having a width 42 and a length 44. The width 42 is generally equal to the distance between the wheel wells of the vehicle 10. The length 44 is generally equal to a length 41 of a cargo space 40 of the vehicle 10 (see FIG. 2). As a result, the floor plate 14 covers a substantial portion of the floor 40 of the interior of the vehicle 10 in the cargo space 40.

The floor plate 14 includes a plurality of mounting holes 46. The mounting holes 46 correspond to the existing mounting holes of the vehicle 10. In this way, the floor plate 14 can be quickly attached to the vehicle 10 by aligning the mounting holes 46 with the existing mounting locations of the vehicle 10 and bolting the floor plate 14 to the floor of the vehicle 10. As a result, the floor plate 14 is configured for rapid installation by taking advantage of the existing mounting features of the vehicle 10. The particular locations of the mounting holes 46 illustrated should be taken by way of example, as their location is generally governed by the mounting locations of the vehicle 10 that the insert will ultimately be incorporated in.

Additionally, the attendant seat 22, the oxygen system 26 mounting, and gurney 32 must all pass what is known as a pull test before the ambulette comprising the installed ambulette insert 12 and vehicle 10 can be put into service. The pull test entails applying a generally horizontal force to the attendant seat 22, oxygen system 26 mounting, and gurney 32. To pass, the attendant seat 22, oxygen system 26 mounting, and gurney 32 must not dislodge from their respective installed positions under the application of the horizontal force.

As a result, the floor plate 14 is designed to mount with the floor such that a sufficient amount of pressure is maintained between the floor plate 14 and the floor. Accordingly, and to further facilitate the rapid installation of the floor plate 14, tension indicating bolts 80 can be used to mount the floor plate 14 with the floor. Tension indicating bolts 80 provide a quick indication of when a sufficient amount of tightening torque has been achieved without the need of a torque wrench or other torque measuring device. The rapid installation of the floor plate 14 to the floor of the vehicle 10 is thus further enhanced by the use of these tension indicating bolts. Usage of these tension indicating bolts 80 also reduces the likelihood that any one of the aforementioned components will fail the pull test as described above.

Still referring to FIG. 3, the floor plate 14 also includes a gurney latching system 48. The gurney latching system 48 includes a bracket 52 and a locking lever 54. The gurney latching system 48 incorporates a standard latch design such that a number of different types of gurneys 32 (see FIG. 1) can be loaded into the ambulette insert 12 and interlocked therewith for short and long distance transportation of a patient. When a gurney 32 is loaded and locked within the vehicle 10, a passenger can still make full use of the front passenger seat. As such, an attendant can ride in the front of the vehicle 10 when the attendant is not required to sit in the attendants seat 22, e.g. when there is no patient present in the vehicle 10.

The floor plate 14 also includes a seat bracket 50. The seat bracket 50 is designed to fixedly mount the attendant seat 22 to the floor plate 14. As a result, the attendant seat 22 can be mounted to the floor plate 14 via the seat bracket 50 prior to installing the floor plate 14 into the vehicle 10. The above functionality further facilitates the rapid installation of the ambulette insert 12 by avoiding the need to install the attendant seat 22 while inside the cargo space 40 of the vehicle 10. However, it will be recognized that the floor plate 14 can be installed without the attendant seat 22, and the attendant seat 22 thereafter installed onto the floor plate 14.

The attendant seat 22 is mounted to the floor plate 14 via the seat mounting bracket 50. The attendant seat 22 is positioned along the floor plate 14 such that an attendant seated therein can provide medical care to a patient carried in a gurney 32 while remaining seated in the attendant seat 22. The attendant seat 22 includes a harness 134 that allows an attendant seated in the attendant seat 22 to freely access the medical console and other medical equipment of the ambulette insert 12 while remaining safely locked to the attendant seat 22. The attendant seat 22 is located proximate to a door 132 (see FIG. 1) of the vehicle 10.

In the illustrated embodiment of FIG. 3, the floor plate 14 is manufactured from a lightweight composite material. By using a lightweight composite material, the floor plate 14 can be hoisted into the cargo space 40 of the vehicle 10 without the use of hoists or a forklift. Additionally, the composite material reduces or minimizes the growth of mold and other blood born pathogens. Furthermore, by using a lightweight composite material for the floor plate 14, the cost of packaging and shipping the ambulette insert 12 is substantially reduced.

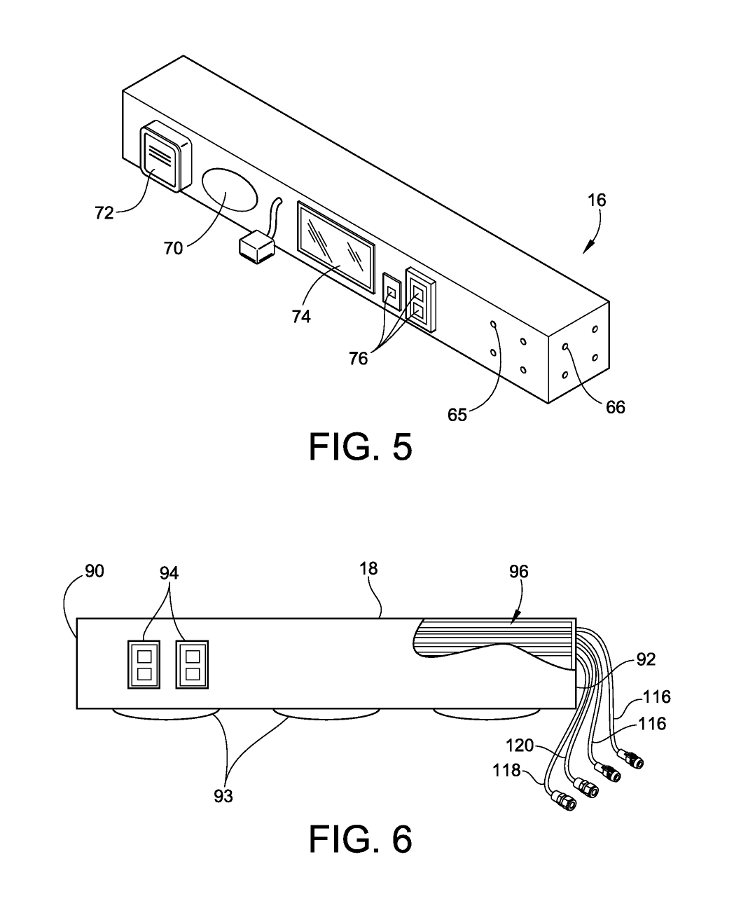

Referring now to FIG. 5, the equipment console 16 extends between the interior sidewalls 62, 64 of the vehicle 10 and proximate to a ceiling 60 thereof (see FIG. 2). In a similar manner as discussed above for the floor plate 14, the equipment console 16 includes a plurality of mounting holes 66 located at either end of the equipment console 16 and sized to correspond with the existing mounting features of the vehicle 10. In this way, the equipment console 16 is installed in the vehicle 10 without the need for additional machining of the interior of the vehicle 10.

As illustrated in FIG. 5, the equipment console 16 includes a variety of medical equipment including a vital sign monitor 74. A variety of diagnostic equipment ports 76 are also provided on the equipment console 16 such that the vital signs of a patient transported in the ambulette insert 12 can be monitored on the vital sign monitor 74. As will be discussed in greater detail below, the vital sign monitor 74 draws electrical power from the existing power plant of the vehicle 10. However, in other embodiments, the ambulette insert 12 is supplied with a stand alone power supply.

Still referring to FIG. 5, the equipment console 16 also includes a variety of storage compartments 70 and a waste container 72. A variety of ports 76 are provided for use with the oxygen system 26, suction system 28, and other medical diagnostic equipment. Although illustrated as incorporating a vital sign monitor 74, storage compartment 70, and a medical waste container 72, the equipment console 16 can be configured with a variety of other commonly used pieces of medical equipment and is not limited to the particular medical equipment discussed above.

Referring now to FIG. 6, the light unit 18 extends transversely away from the equipment console 16 toward the rear of the vehicle 10 (see FIG. 1). The light unit 18 mounts directly to the equipment console 16 at a forward end 90 of the light unit and is supported by the support conduit 20 at a rear end 92 of the light unit 18 (see FIG. 4). The light unit 18 is generally situated proximate to the ceiling 60 of the vehicle 10 and is designed to illuminate the area above a gurney 32 carried by the ambulette insert 12 (see FIG. 2).

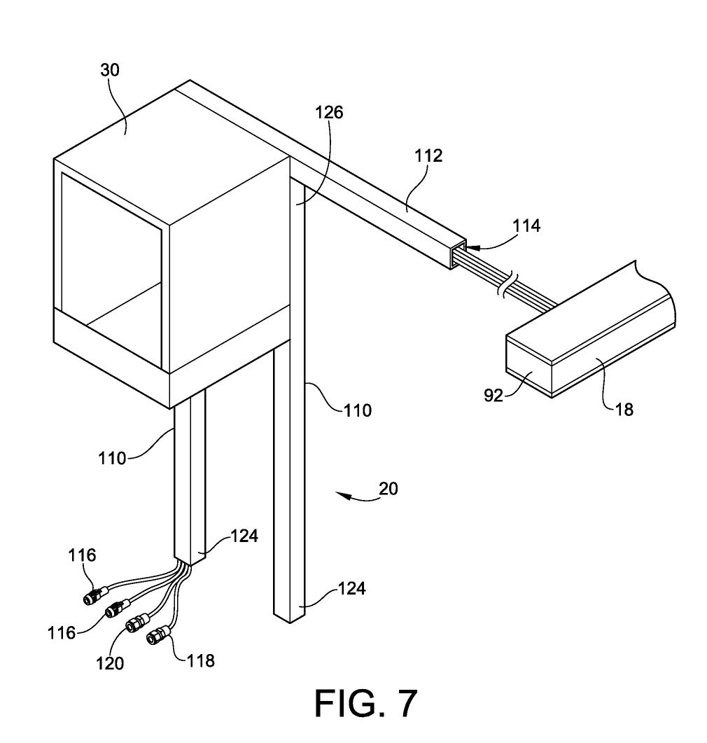

The light unit 18 is designed to provide variable intensity lighting via lights 93 over a passenger carried in a gurney 32 (see FIG. 1) loaded into the ambulette insert 12. Additionally, the light unit 18 also provides a plurality of ports 94 similar to the equipment ports 76 of the equipment console 16. As will be discussed in greater detail below, the light unit 18 includes a hollow portion 96 so that electrical leads 116 and mechanical leads in the form of hoses 118, 120 from the oxygen system 26 and the suction system 28 can be routed to the equipment console 16 through the light unit 18 (see FIG. 7).

With momentary reference to FIG. 1, the support conduit 20 extends between the floor plate 14 and the ceiling 60 (see FIG. 2) of the vehicle 10. As will be discussed in greater detail below, the support conduit 20 supports the rear end 92 of the light unit 18 to support the light unit 18 due to its otherwise cantilever extension from the equipment console 16.

Referring now to FIG. 7, the support conduit 20 includes a plurality of vertical support members 110 and a horizontal support member 112 such that the support conduit 20 has a generally “L” shaped profile. The vertical support members 110 are fixedly attached to the floor plate 14 at a first end 124 of the vertical support members 110. The horizontal support member 112 extends transversely away from a second end 126 of the vertical support members 110. As best illustrated in FIG. 7, the light unit 18 mounts to the horizontal support member 112 at or proximate to the rear end 92 of the light unit 18.

With continued reference to FIG. 7, the support conduit 20, and more particularly the vertical support members 110 and horizontal support member 112, includes a hollow core 114 configured to allow the routing of a oxygen hose 120, a suction hose 118, and electrical cables 116 through the support conduit 20. The cables 116, suction hose 118, and oxygen hose 120 are routed through the support conduit 20 such that they interconnect with the equipment ports 76 of the equipment console 16 and the equipment ports 94 of the light unit 18. As a result, the support conduit 20 allows for organized containment of the requisite electrical and mechanical leads of the ambulette insert 12.

The support conduit 20 also includes a storage compartment 30 affixed thereto. The storage compartment 30 is affixed to the support conduit 20 and allows for the additional storage of medical equipment and supplies not otherwise stored in the equipment console 16. Similar to the floor plate 14, the support conduit 20 is manufactured from a lightweight material such as for non limiting example an aluminum alloy, or a composite material. The material used to manufacture the support conduit 20 is light enough to facilitate packaging, shipping, and installation while also structurally rigid enough to support the light unit 18 and the storage compartments 30 affixed to the support conduit 20.

Having discussed the structural attributes of an embodiment of the ambulette insert 12, the following describes the use of the ambulette insert 12, to include the reconfiguration of a vehicle 10 with an ambulette insert 12 so that the vehicle can function as an ambulette.

As discussed above, the ambulette insert 12 allows a user to rapidly reconfigure a vehicle 10 to function as an ambulette type vehicle for the long and short distance transportation of patients in non-emergency situations. To reconfigure a vehicle 10 with the ambulette insert 12, the attendant seat 22 is first attached to the floor plate 14. The floor plate 14 is then hoisted by hand into the cargo space 40 of the vehicle 10. The mounting holes 46 of the floor plate 14 are aligned with mounting holes located on the floor 40 of the vehicle 10. The floor plate 14 is then bolted to the floor 40 of the vehicle 10.

Next, the equipment console 16 is aligned with the mounting holes of the vehicle 10 located on the interior sidewalls 62, 64 of the vehicle 10. The equipment console 16 is then mounted to the interior sidewalls 62, 64 via the mounting holes 66 of the equipment console 16. The light unit 18 is then mounted with the equipment console 16 and the various cables required for using the equipment contained in the equipment console 16 are then routed through the light unit 18.

Once the floor plate 14, equipment console 16, and light unit 18 are installed, the support conduit is then attached to the floor plate 14. The various cables running from the equipment console 16 and light unit 18 are then routed through the support conduit 20 and attached to their corresponding source. The rear end 92 of the light unit 18 is then mounted with the horizontal member 112 of the support conduit 20.

Once the above assembly is complete, the vehicle 10 is ready to function as an ambulette. To use the ambulette, a patient is loaded onto a gurney 32. The gurney 32 is then loaded onto the floor plate 14 of the ambulette insert 12 and interlocked therewith. The attendant then sits in the attendant seat 22 and secures themselves to the attendant seat 22 with the harness 134. While seated in the attendant seat 22, the attendant can access various medical equipment in the equipment console 16 as well as access a patient carried within the gurney 32. The attendant can also utilize the oxygen system 26 and the suction system 28 of the ambulette insert 12 via the equipment ports 76 of the equipment console 16 and the equipment ports 94 of the light unit 18. More particularly, the attendant can attach an oxygen mask to either of the equipment ports 76, 94 or a suction tube to either of the ports 76, 94. Furthermore, the attendant can attach vital sign diagnostic equipment such as for example a heart monitor or similar device to the equipment ports 76, 94 so that a patient's vital signs can be monitored via the vital sign monitor 74.

Once a long or short distance transportation is completed, a patient can be removed from the ambulette insert 12 by first unlocking the gurney 32 from the floor plate 14 via the gurney latching system 48. The attendant then exits the vehicle 10 and removes the gurney 32 from the rear of the vehicle 10 once the gurney 32 is unlocked. The gurney 32 can then be left in an angled, partially upright state to allow the passenger seat to be positioned away from dash of the vehicle 10 to such an extent as to allow the attendant to sit in the passenger seat.

While the above method presents a sequential ordering for the assembly and use of the ambulette insert 12, the assembly and use thereof is not so limited. In other embodiments, a different order of operations can be followed to assemble and use the ambulette inert 12. For example, the medical console, support conduit 20, attendant seat 22, and the floor plate 14, or any subset of the preceding list, can be supplied preassembled such that the insert 12 can be installed into the interior of the vehicle 10, leaving only minimal assembly required thereafter.

As discussed above, the ambulette insert 12 facilitates the rapid low cost reconfiguration of a vehicle 10 so that the vehicle 10 can function as an ambulette. The ambulette insert 12 accomplishes this functionality by mounting with the existing mounting features of a vehicle 10. By using the existing mounting features of the vehicle 10, no additional machining of the vehicle 10 is required by the end user. Furthermore, by using lightweight composite materials for the construction of the ambulette insert 12, the ambulette insert 12 can be packaged, shipped, and installed using minimal resources in an optimized fashion.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A modular ambulette insert for a vehicle, comprising:
a floor plate configured to fixedly mount to a floor of the vehicle;
a support conduit extending generally upward and away from the floor plate; and
a medical console supported by the support conduit and disposed above the floor plate.

2. The insert of claim 1, wherein the medical console includes an equipment console and a light unit.

3. The insert of claim 2, wherein the light unit extends transversely away from the equipment console.

4. The insert of claim 3, wherein the light unit has an internal cavity adapted to route mechanical and electrical leads from the equipment console and the light unit to the support conduit.

5. The insert of claim 1, wherein the floor plate includes a plurality of mounting holes, the plurality of mounting holes adapted to align with pre-existing mounting locations of a vehicle.

6. The insert of claim 1, wherein the floor plate includes a gurney latching system mounted thereto.

7. The inert of claim 1, wherein the floor plate includes an attendant seat mounted thereto.

8. The insert of claim 1, further comprising a suction system, the suction system including mechanical leads that extend from a base unit to the equipment console, the mechanical leads extending through the cavity of the light unit.

9. The insert of claim 1, further comprising an oxygen system, the oxygen system including mechanical leads that extend from a tank thereof to the equipment console, the mechanical leads extending through the cavity of the light unit.

10. A method for configuring a light commercial vehicle to operate as an ambulette, the method comprising:
installing a modular ambulette insert in an interior of the vehicle; and
mounting the modular insert to the existing mounting locations of the vehicle.

11. The method of claim 10, further comprising the steps of mounting a support conduit to a floor plate of the modular insert and mounting a medical console to the support conduit such that the medical console is supported by the support conduit prior to the step of installing the modular ambulette insert.

12. The method of claim 11, further comprising the step of mounting an attendant seat to the floor plate prior to the step of installing the modular ambulette insert.

13. The method of claim 10, wherein the step of mounting includes mechanically affixing a floor plate of the modular ambulette insert to a floor of the vehicle.

14. The method according to claim 13, wherein the step of mounting includes mechanically affixing the floor plate to the floor of the vehicle using tension indicating bolts.

15. The method of claim 10, further comprising the step of affixing sidewall coverings to interior walls of the vehicle.

16. The method of claim 13, wherein the step of installing the modular insert includes affixing a support conduit to the floor plate after mechanically affixing the floor plate to the to the floor of the vehicle.

17. The method of claim of claim 16, further comprising the step of affixing a medical console to the interior of the vehicle and to the support conduit after affixing the support conduit to the floor plate.

18. The method of claim 17, further comprising the step of affixing an attendant seat to the floor plate after mechanically affixing the floor plate to the floor of the vehicle.
